(19) United States
(12) Patent Application Publication
(10) Pub. No.: US 2015/0262449 A1
(43) Pub. Date: Sep. 17, 2015

(54) Electronic Gaming Machine and Gaming Method

(71) Applicant: Ainsworth Game Technology Limited, Newington (AU)

(72) Inventor: Jason Meyer, Abbotsford (AU)

(21) Appl. No.: 14/519,479

(22) Filed: Oct. 21, 2014

(30) Foreign Application Priority Data
Mar. 12, 2014 (AU) 2014900845

(51) Int. Cl. G07F 17/32; G07F 17/34

(52) U.S. Cl. CPC G07F 17/3213; G07F 17/34

(57) ABSTRACT

An electronic gaming machine includes a housing having a display for displaying a game array of randomly selected game symbols, an electronic game controller in electronic communication with said display and an input device in electronic communication with said electronic game controller for receiving commands from a player to operate said electronic gaming machine. The electronic game controller randomly determines the number of game symbols displayed in the game array for each play of said game on said game array. The randomly determined number of displayed game symbols is randomly selected from a maximum number to a minimum number of game symbols. All of the game symbols displayed in the game array are eligible to form at least one winning combination of game symbols for the payment of winnings by the electronic gaming machine. A gaming method is also provided.

### BACKGROUND

The invention relates to an electronic gaming machine and in a particular an electronic gaming machine providing a game based on a plurality of reels. The invention has been developed primarily for use as an electronic gaming machine providing a game based on spinning video reels and will be described hereinafter by reference to this application.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

Bonus or “feature” games may also be provided by an electronic gaming machine in addition to a base or main game. Typically feature games use the same set of reels as the main game and are limited to a set of free games operated under a single set of rules. Once the free feature games have been played, the electronic gaming machine resets itself and returns the player back to the base game. This means that the feature game is restricted by the same set of rules, and so there is no variation in the play of the feature game.

This standard structure to game play limits the variation in the play of the electronic gaming machine. Consequently, it is difficult to retain player interest because there is no apparent incentive for the player to continue playing the same electronic gaming machine once the player becomes familiar with the feature game base game and jackpot prize features. Also, it is difficult to retain player interest since there is little differentiation between gaming machines in terms of the base and feature games that are played, and any associated jackpot or bonus prizes.

It is an object of the present invention to overcome or substantially ameliorate one or more of the disadvantages of prior art, or at least to provide a useful alternative. It is an object of the invention in at least one preferred form to provide an electronic gaming machine and gaming method that encourages player interest.

### SUMMARY

According to a first aspect of the invention, there is provided an electronic gaming machine comprising:

a display for displaying a main game array of randomly selected game symbols, said array of having at least one variable dimension, and

an electronic game controller for controlling the display of said array,

wherein said electronic game controller randomly determines the number of game symbols displayed in said array for each play of a game on said array, said randomly determined number of displayed game symbols being randomly selected from a maximum number to a minimum number of game symbols that can be displayed in said array, and

wherein all of said game symbols displayed in said array are eligible to form at least one winning combination of game symbols for the payment of winnings by the electronic gaming machine.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Preferably, the array includes a plurality of reels displayed within the array and the number of game symbols displayed for each reel is randomly selected by the electronic game controller within a predetermined range. More preferably, the predetermined range includes one or more game symbols. In one preferred form, the number of symbols randomly selected for each reel is determined independently of the other reels.

Preferably, said reels comprise columns of game positions located substantially adjacent each other. Alternatively, said reels comprises rows of game positions located substantially adjacent each other. In one preferred form, said reels visually rotate to simulate rotation of a mechanical reel. In another preferred form, each said game position comprises an individual spinnable reel.

Preferably, said at least one variable dimension comprises the size of one or more game positions in which said game symbols are displayed on said array. Alternatively or additionally, said at least one variable dimension comprises the shape of said array on said display. More preferably, said electronic game controller randomly selects at least one array shape from a set of predetermined array shapes. In one preferred form, more than one array shape is selected randomly and is displayed on said display. The shapes of said arrays are preferably rectangular, circular, triangular, oval, semi-circular, hexagonal, pentagonal, triangular, square, polygonal, letter shapes (A, X T, etc.), shapes that represent animals or items, or even irregular shapes.

Preferably, the array varies in said at least one dimension for at least two consecutive plays of said game, each said consecutive play being initiated by a bet made by said player. More preferably, the number of game symbols displayed is different for said at least two consecutive plays and the bet made by the player for each said consecutive game play is identical. Alternatively, it is preferred that the number of game symbols displayed is different for said at least two consecutive plays and the bet made by said player for each said consecutive game play is different.

Preferably, said winnings are paid on paylines comprising one or more game positions within the array. Alternatively or additionally, it is preferred that said winnings are paid on patterns comprising one or more game positions within the array.

Preferably, said array is formed by a symmetrical pattern of said randomly selected and displayed game symbols.

Preferably, the number of game symbols displayed is less than the number of game positions randomly selected to be displayed by the electronic game controller. Alternatively, it is preferred that said electronic game controller causes said array to display a variable number of game positions corresponding to said randomly determined number of game symbols so as to display said randomly determined number of game symbols in said array.

Preferably, said game comprises a base game. Alternatively or additionally, it is preferred that said game comprises a feature game.

Preferably, the same game symbols are used in said feature game and said base game. Alternatively, different game symbols or a mixture of the same and different game symbols are used in said feature game and said base game.

Preferably, said electronic game controller causes the display of said feature game in response to a feature game trigger event. Alternatively, said electronic game controller causes the display of said feature game and said base game during play of said base game, said feature game being inactive until triggered. In this preferred form, the change in said feature game from being inactive to active may be indicated on the display.

Preferably, said electronic game controller causes the display of said base game on a separate display to said display. Alternatively, said electronic game controller causes the display of said feature game and said base game on the same display.

Preferably, the player selectively starts and/or stops play of said reels in said game array and/or said reels in said feature game.

Preferably, said electronic gaming machine comprises input means for receiving said player selection and said designated player selection, wherein said input means comprises one or more buttons in electronic communication with said electronic game controller to transmit said player selection and said designated player selection to said electronic game controller.

Preferably, said electronic gaming machine comprises input means for receiving said player selection and said designated player selection, wherein said input means comprises a touch sensitive surface on said display for receiving said player selection and said designated player selection, said touch sensitive surface being in electronic communication with said electronic game controller to transmit said player selection and said designated player selection to said electronic game controller.

Preferably, said input means comprises one or more buttons on said housing, said buttons being in electronic communication with said electronic game controller to transmit player commands to said electronic game controller. More preferably, said buttons are arranged on a console of said housing. Alternatively or additionally, said input means comprises a touch sensitive surface on said display for receiving player commands, said touch sensitive surface being in electronic communication with said electronic game controller to transmit player commands to said electronic game controller.

Preferably, said housing comprises a value transfer mechanism for paying said prizes to said player using value in an amount equal to an awarded prize. More preferably, said value transfer mechanism also receives value from said player to initiate said bet. In one embodiment, said value transfer mechanism comprises one or more vending slots for paying and/or receiving value. In other embodiments, said value transfer mechanism comprises a value input/value output device. In further embodiments, said value transfer mechanism comprises a coin slot or acceptor, a paper currency acceptor, a ticket reader and/or printer or a card reader and/or writer.

Throughout the specification and unless explicitly stated otherwise, the term “value” means credits, gaming tokens, coins, paper, currency, tickets, vouchers, credit cards, debit cards, smart cards, memory devices capable of storing value and any other object representative of value.

Preferably, said game symbols in said feature game and said base game are arranged in arrays of the same shape or type. Alternatively, said game symbols in said feature game and said base game are arranged in differently shaped arrays. The shapes of said arrays are preferably rectangular, circular, triangular, oval, semi-circular or other non-rectangular shape.

Preferably, said electronic game controller causes the display of said feature game in response to said trigger event. Alternatively, said electronic game controller causes the display of said feature game and said base game during play of said base game, said feature game being inactive until triggered. In this preferred form, the change in said feature game from being inactive to active may be indicated on the display.

Preferably, the electronic gaming machine comprises a mobile electronic gaming device. More preferably, said mobile electronic gaming device comprises a handheld electronic device. Alternatively, said electronic gaming machine comprises a computer. More preferably, said computer is connected to a communication network.

A second aspect of the present invention provides an electronic gaming machine comprising:

a housing having a display for displaying a game array of randomly selected game symbols and an electronic game controller in electronic communication with said display for controlling the appearance of game symbols in said game array on the display, wherein said game array has at least one variable dimension;

wherein a game comprises displaying said randomly selected game symbols in said game array and predetermined winning combinations of game symbols causes said electronic gaming machine to pay winnings to a player; and

an input means for receiving commands from said player to operate said electronic gaming machine and initiate play of said game on said display, said input means being in electronic communication with said electronic game controller;

wherein said electronic game controller in response to a command from said player via said input means commences play of said game by randomly selecting game symbols and transmitting a signal to said display to display said randomly selected game symbols;

said electronic game controller randomly determines the number of game symbols displayed in said game array for each play of said game on said game array, said randomly determined number of displayed game symbols being randomly selected from a maximum number to a minimum number of game symbols that can be displayed in said array; and

all of said game symbols displayed in said array are eligible to form at least one winning combination of game symbols for the payment of winnings by the electronic gaming machine.

This second aspect of the invention preferably has the preferred features of the first aspect of the invention stated above, where applicable.

According to a third aspect of the invention, there is provided a gaming method for an electronic gaming machine comprising a display and an electronic game controller, the method comprising said electronic game controller:

controllably displaying an array of randomly selected game symbols so that said array has at least one variable dimension;

randomly determining the number of game symbols displayed in said array for each play of a game on said array by randomly selecting from a maximum number to a minimum number of game symbols that can be displayed in said array;

determining whether one or more of a plurality of winning combinations of game symbols is displayed on said array for each said play, all of said game symbols displayed in said array being eligible to form at least one of said winning combinations, and

in response to said one or more of said winning combinations being displayed in said array on a play of said game, causing said electronic gaming machine to pay winnings for said play.

Preferably, said method comprises arranging said array to display a plurality of reels and randomly selecting the number of game symbols displayed for each said reel within a predetermined range. More preferably, the predetermined range includes one or more game symbols. In one preferred form, said random selection of the number of symbols for each reel is determined independently of the other reels.

Preferably, said method comprises varying the size of one or more game positions in which said game symbols are displayed on said array. Alternatively or additionally, the method preferably comprises varying the shape of said array on said display. More preferably, said method comprises randomly selecting at least one array shape from a set of predetermined array shapes. In one preferred form, more than one array shape is selected randomly and is displayed on said display.

Preferably, said method comprises varying said array in said at least one dimension for at least two consecutive plays of said game, each said consecutive play being initiated by a bet made by said player. More preferably, said method comprises displaying a different number of game symbols for said at least two consecutive plays, wherein the bet made by the player for each said consecutive game play is identical. Alternatively, said method preferably comprises displaying a different number of game symbols for said at least two consecutive plays, wherein the bet made by said player for each said consecutive game play is different.

Preferably, said method comprises paying winnings on one or more paylines, each payline comprising one or more game positions within the array. Alternatively or additionally, the method preferably comprises paying winnings on patterns comprising one or more game positions within the array.

Preferably, said array is formed by a symmetrical pattern of said randomly selected and displayed game symbols.

Preferably, said method comprises displaying a number of game symbols less than the number of game positions randomly selected to be displayed. Alternatively, said method preferably comprises causing said array to display a variable number of game positions corresponding to said randomly determined number of game symbols so as to display said randomly determined number of game symbols in said array for each said play.

The method preferably has the preferred features of the first aspect of the invention stated above, where applicable.

A fourth aspect of the present invention provides a gaming method for an electronic gaming machine comprising a housing having a display for displaying a game, wherein said game comprises game symbols and predetermined winning combinations of randomly selected game symbols in said game award prizes to a player; an electronic game controller inside said housing for controlling the display of said game symbols for playing said game on said display; and an input means for receiving commands from said player to operate said electronic gaming machine, said input means being in electronic communication with said electronic game controller, the method comprising:

said electronic game controller receiving a command from said player via said input means to initiate play of said game on said display;

said electronic game controller controllably displaying an array of randomly selected game symbols so that said array has at least one variable dimension;

said electronic game controller randomly determining the number of game symbols displayed in said array for each play of a game on said array by randomly selecting from a maximum number to a minimum number of game symbols that can be displayed in said array;

said electronic game controller commencing said play of said game by transmitting a signal to said display to display said randomly selected game symbols;

said electronic game controller determining whether one or more of a plurality of winning combinations of game symbols is displayed on said array for each said play, all of said game symbols displayed in said array being eligible to form at least one of said winning combinations; and

in response to said one or more of said winning combinations being displayed in said array on a play of said game, said electronic game controller causes said electronic gaming machine to pay winnings for said play.

The method of the fourth aspect of the invention preferably has the preferred features of the second and third aspects of the invention stated above, where applicable.

According to a fifth aspect of the invention, there is provided a computer system comprising a central processing unit configured for communication with an electronic gaming machine, wherein said computer system is configured to perform the method of the third or fourth aspects of the invention.

According to a sixth aspect of the invention, there is provided a computer program configured to perform the method of the third or fourth aspects of the invention.

According to a seventh aspect of the invention, there is provided a non-transitory carrier medium carrying computer executable code that, when executed on a central processing unit configured for communication with an electronic gaming machine, causes the central processing unit to perform the method of the third or fourth aspects of the invention.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine that may be used with any of the embodiments of the present invention;

FIG. 2 is a schematic drawing of an electronic game controller for the electronic gaming machine of FIG. 1;

FIG. 3 is a schematic front view of a display of a prior art electronic gaming machine;

FIG. 4 is a schematic front view of a first embodiment of the present invention,

FIG. 5 is a schematic front view of a second embodiment of the present invention,

FIG. 6 is a schematic front view of a third embodiment of the present invention,

FIG. 7 is a schematic front view of a fourth embodiment of the present invention.

### DETAILED DESCRIPTION OF VARIOUS EMBODIMENTS

The present invention will now be described with reference to the following examples which should be considered in all respects as illustrative and non-restrictive. In the Figures, corresponding features within the same embodiment or common to different embodiments have been given the same reference numerals.

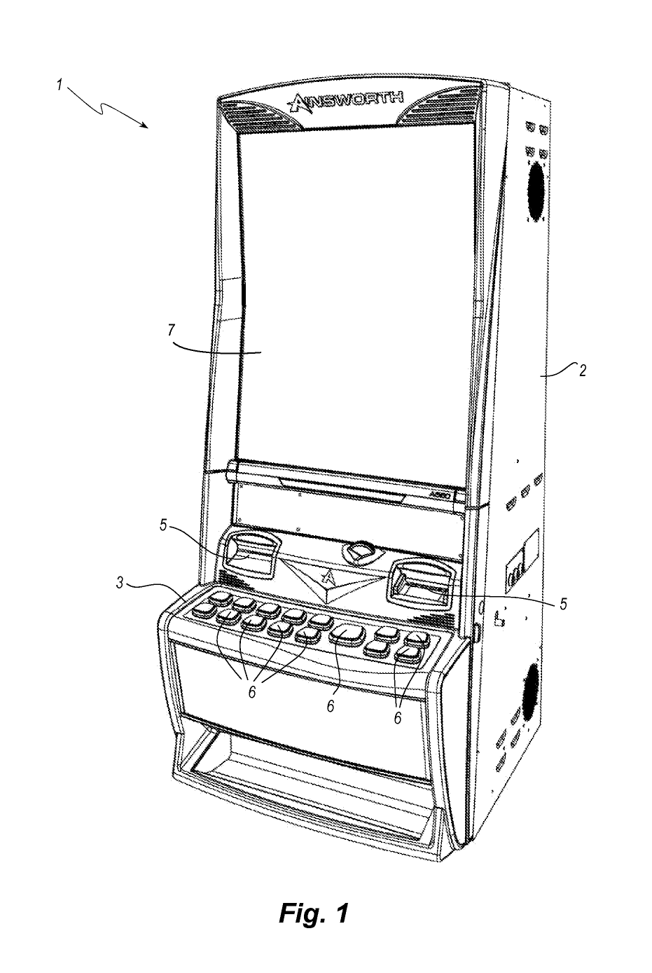

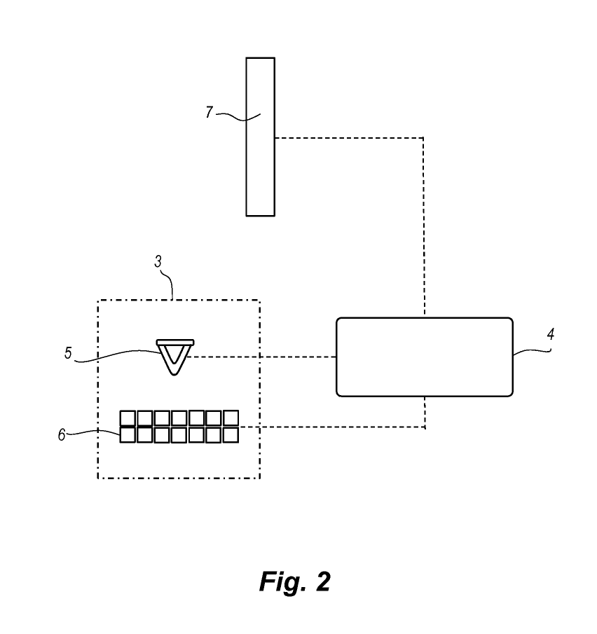

Referring to FIGS. 1 and 2, an electronic gaming machine 1 according to a one embodiment of the invention includes a cabinet 2, a console 3 and an internal electronic game controller 4. The console 3 has various input devices including vending slots 5 for receiving monetary bets and a plurality of buttons 6 for actuation by a player. It will be appreciated that in other embodiments the vending slots 5 may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the electronic gaming machine 1. Other forms of value include gaming tokens, paper, tickets, vouchers, and any other object representative of value.

The electronic game controller 4 is generally in the form of a central processing unit, such as a computer, and is in electronic communication with a display in the form of a video display screen 7, as well as various input devices on the console 3. Typically, the electronic game controller 4 also comprises a random access memory (RAM) associated with the central processing unit, the RAM being used to store program instructions and transient data related to the operation of the electronic game controller and hence the electronic gaming machine 1. The RAM contains a body of program instructions for implementing a game on the electronic gaming machine 1, as discussed in more detail below. The central processing unit or processor may also be operatively associated with a further storage device, such as a hard disk drive, which is used for long-term storage of program components and data relating to the electronic game controller 4 and/or the electronic gaming machine 1, including a database for game performance data, as well as information gathered from users. It is also appreciated that a person skilled in the art would readily understand the location and use of the electronic game controller 4 in the electronic gaming machine 1.

The electronic game controller 4 is generally in the form of a central processing unit, such as a computer, and is in electronic communication with a display in the form of a video display screen 7, as well as various input devices on the console 3, as best shown in FIG. 2. It is also appreciated that a person skilled in the art would readily understand the location and use of the electronic game controller 4 in the electronic gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the electronic gaming machine 1. If not, the electronic game controller 4 will send a signal to the display 7 to show a message requesting further value to be added to the electronic gaming machine 1.

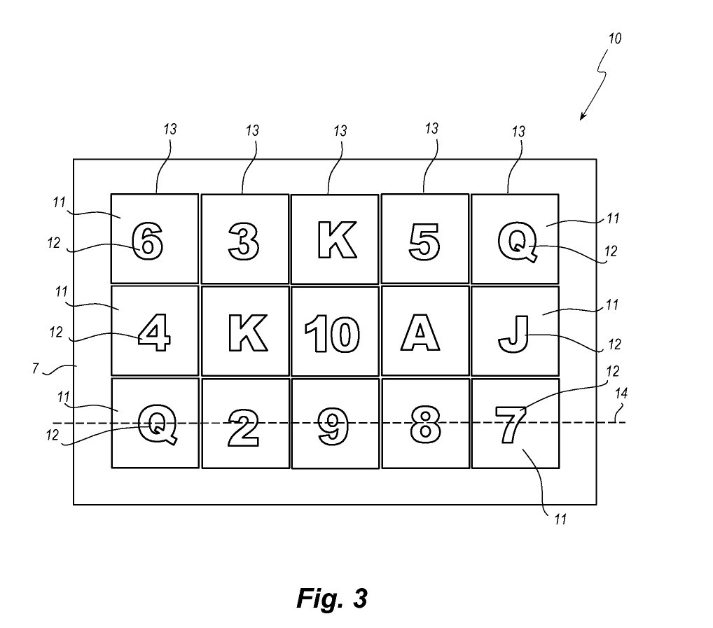

Referring to FIG. 3, a schematic front view of a prior art display of an electronic gaming machine is shown. In this example, an array 10 of multiple game positions 11 that each show gaming symbols 12 is depicted in a 5×3 grid or matrix within a play area. The overall array 10 has a generally square or rectangular shape and comprises five reels 13. During game play, a player may select a bet or wager level and may also select a number of paylines 14 based on the selected bet or wager level. The paylines 14 are usually predetermined combinations of game or symbol positions 11, and typically comprise at least one game position from each reel 13. The number of paylines 14 that can be selected by the player depends on the amount of the monetary bet for playing a game on the array 10. The electronic game controller 4 then typically causes the reels 13 to rotate and randomly depict a fixed number of randomly selected game symbols 12 within the array 10. In this example of the prior art, fifteen game symbols 12 are depicted in each game position 11, being symbols representing playing cards. It is generally noted that the playing card symbols may be replaced by any kind of representative symbol to match the overall theme of the game.

If the symbols 12 and paylines 14 match a set of predetermined winning combinations as described by a paytable (not shown), the player is awarded a prize which is usually proportional to the likelihood of the winning combination multiplied by the initial bet or wager.

The game symbols 12 can include a mixture of picture symbols (such as animal symbols or playing card symbols), word symbols, scatter symbols, substitute or wild card symbols and trigger symbols. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. Similarly, a trigger symbol is a symbol that triggers a game event (like activating a feature game) or confers an award, where the trigger symbol may or may not have to appear in combination and may or may not have to appear on the same player-selected pay line 14.

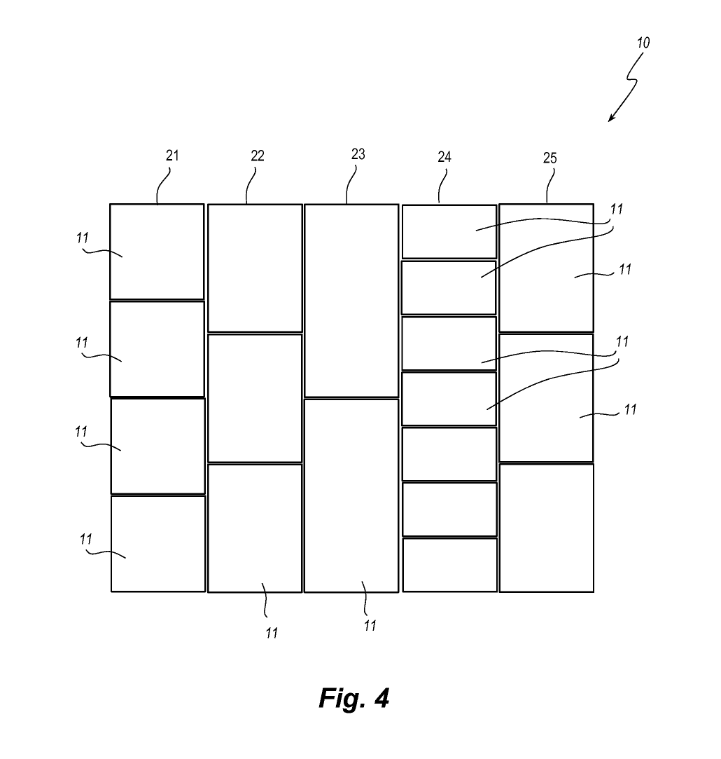

FIGS. 4 to 7 depict various embodiments of the present invention, where corresponding features have been given the same reference numerals. In these figures, a display screen 7 is shown of an electronic gaming machine 1. Alternately, the electronic gaming machine 1 may also be called or named a video gaming machine. The display 7 depicts an array 10 of selected game positions 11 showing randomly selected game symbols 12. In other embodiments, the game or symbol positions 11 are not visually marked by boundary lines and simply provide an area for the game symbols 12 to appear. Preferably, the array 10 is of a non-fixed (i.e. variable) size and may be randomly changed by the electronic game controller 4 that controls the game play on the electronic gaming machine 1.

Preferably, the array 10 being of a non-fixed size refers to the feature wherein the number of game positions 11 and/or the number of gaming symbols 12 shown on the screen 7 may vary or change on subsequent games. This variation of the number of game positions 11 and/or the number of game symbols 12 shown on the screen 7 is preferably not connected or related to the player's chosen bet or betting option such as payline selection, but is randomly generated by the electronic game controller 4. It is noted that that the non-fixed size of array 10 does not include the overall shape of array, but refers to the arrangement of the game positions 11 within the array. The overall shape of the array 10 may remain the same during subsequent game play depending on the preferred embodiment which is implemented.

FIG. 4 depicts a game area within a preferred array. The array 10 is in a generally rectangular shape and includes five reels 21, 22, 23, 24 and 25. However, it will be appreciated that there can be a greater or less number of reels used within the array to similar effect.

A first reel 21 in this embodiment has been selected by the game controller to include four game positions 11 (and hence four gaming symbols 12). Preferably, the electronic game controller 4 may select one or more game positions 11 (and hence game symbols 12) to be shown on the reel 21. The same methodology is applied to the second reel 22, third reel 23, fourth reel 24, and fifth reel 25. The second reel 22 shows three game positions 11 (and hence three gaming symbols 12). The third reel shows two game positions 11 (and hence two gaming symbols 12). The fourth reel 24 shows seven game positions 11 (and hence seven gaming symbols 12); and the fifth reel 25 shows three game positions 11 (and hence three gaming symbols 12). In this embodiment, the associated paylines 14 may remain the same as traditional or conventional games of chance, however one shown game position 11 (and hence one gaming symbol 12) may be included on multiple paylines as the same game symbol may occur in a larger or bigger game position in the array 10 and paylines may be identical or similar to traditional games of chance.

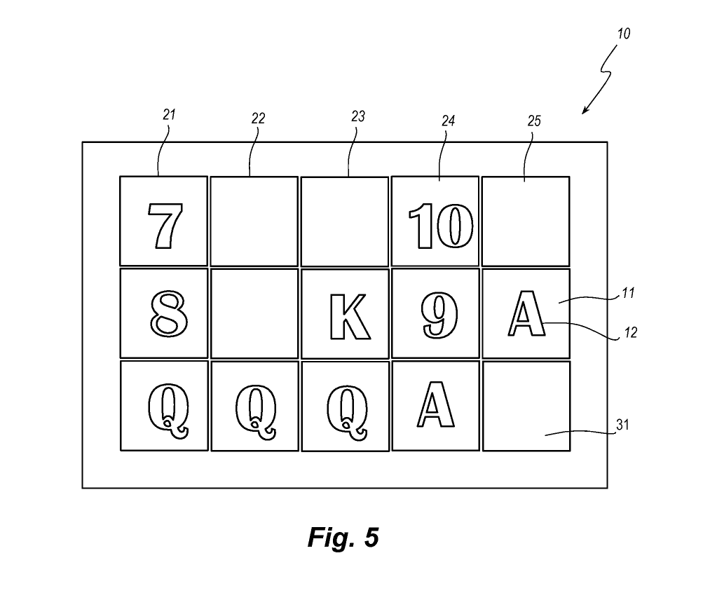

A second preferred embodiment is shown in FIG. 5, wherein the array 10 includes five reels as per the earlier embodiment. However, in this embodiment some of the gaming symbols 12 have been omitted or removed by the electronic game controller 4. The game positions 31 in which the game symbols 12 would have appeared still remain visible in the array 10. In a variation of this embodiment, the game positions 31 are also omitted or removed to show what appears to be an incomplete array or an array having an irregular shape.

In reference to the second reel 22, two game positions 11 (and hence two gaming symbols 12) have omitted and there is only one game position 11 and hence one gaming symbol 12 on this reel that is visible as part of the array 10. In this embodiment, the electronic game controller 4 which operates the game randomly chooses which gaming symbols 12 to omit or randomly decides how many gaming symbols on each reel to reveal to the player through the array 10.

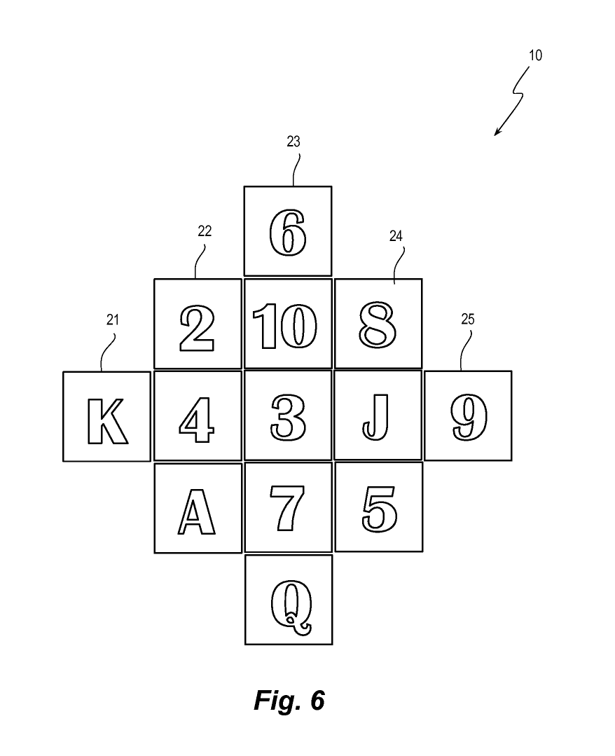

A third preferred embodiment of the present invention is depicted in FIG. 6, wherein the array 10 also comprises five reels, but the game positions 11 within the array 10 have been modified or adapted to allow the array to be shaped in a generally diamond shape. Preferably, the array 10 could be formed into any symmetrical pattern using different reel lengths, but in the illustration depicted in FIG. 6 the array is shown in a symmetrical diamond shape.

In this embodiment, the lengths of reels have been modified but the size of each game position 11 (and hence each game symbol 12) is identical to each other. In comparison, in FIG. 4 the size of the game positions 11 (and hence the game symbols 12 shown in each game position) was modified to retain the same overall array shape constantly through game play. Thus, in FIG. 6, the reels 21 to 25 each have different lengths relative to each other.

Further, the preferred electronic game controller 4 may be adapted to display and work with the third embodiment, by storing in its memory a set of predetermined array shapes. The electronic game controller may randomly select one of the stored set of predetermined array shapes and apply this to the outcome of the game. In the example shown in FIG. 6, the electronic game controller 4 has applied a general diamond shape, but other predetermined shapes of arrays may also be applied, such as rectangular, circular, triangular, oval, semi-circular, hexagonal, pentagonal, triangular, square, polygonal, letter shapes (A, X T, etc.), shapes that represent animals or items, or even irregular shapes. Alternatively, the arrays 10 could have an uneven number of rows and/or columns. For example, two of the reels could have three rows, but three other reels could have four rows.

Generally, the diamond shape of FIG. 6 is produced by: the first reel 21 showing one game position 11 (and hence one gaming symbol 12), the second reel 22 showing three game positions 11 (and hence three game symbols 12), the third reel 23 showing five game positions 11 (and hence five gaming symbols 12), the fourth reel 24 shows three game positions 11 (and hence three gaming symbols 12), and the fifth reel 25 shows one game position 11 (and hence one gaming symbol 12).

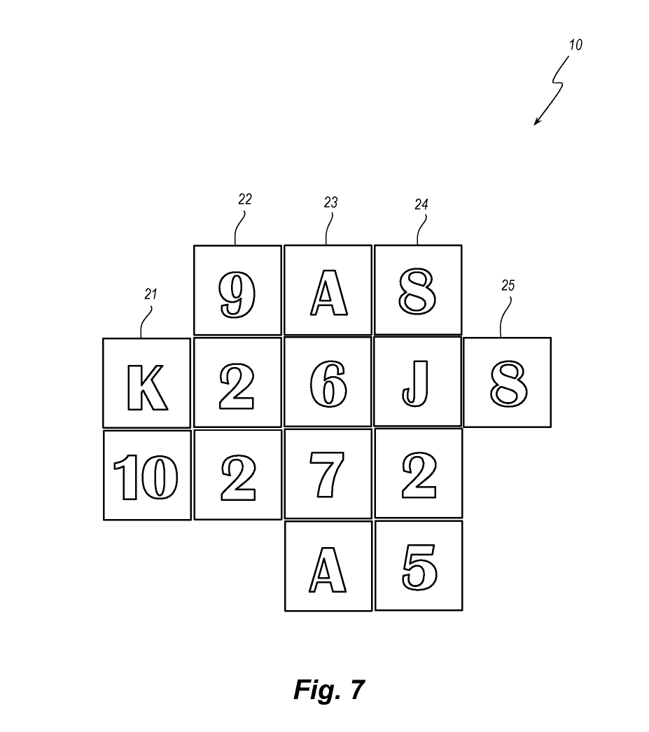

The fourth preferred embodiment of the present invention is illustrated in FIG. 7. This embodiment is similar to the third embodiment, as the size of the game positions 11 (and hence its displayed gaming symbols 12) remains relatively constant, but the overall lengths and sizes of the reels 21 to 25 changed or modified to accommodate the variance in the number of game positions 11 (and hence gaming symbols 12) shown in each reel.

Preferably, in this embodiment, the electronic game controller 4 has not applied a fixed predetermined shape or configuration for the array 10. Rather, the overall shape of the array 10 has been randomized which is different to the third embodiment shown in FIG. 6.

The array 10 shown in the fourth embodiment includes the other features of the earlier described embodiments, such as the number of game positions 11 (and hence the number of displayed gaming symbols 12) shown on each reel has been randomised.

All of the arrays 10 shown in the above described embodiments have been preferably applied to the base game of chance or the main game. However, the arrays 10 of the preferred embodiments may also be applied to a feature game, or to both a base game and its associated feature game(s). Further improvements to the game of chance or gaming devices may also allow these features to be applied to trigger events occurring within the game play or to feature game events.

All of arrays shown in respect of the above described embodiments may be considered as non-fixed or variable size main game arrays.

It should also be noted that there is no trigger event associated with varying the size of the array 10. Rather, the random variation of the array occurs automatically and is part of the play of the game.

It will be appreciated that in other embodiments, game enhancing elements can be awarded in the feature game in addition or as an alternative to the enhanced prizes awarded based on winning combinations of game symbols. The award of game enhancing elements can be done by way of a sixth reel or the appearance of game enhancing symbols in the reels. A variety of game enhancing elements can be awarded by the game enhancing symbols, including:
symbols that award a predetermined number of free plays of said game;
win multiplier symbols that multiply the amount of any win from one of said predetermined winning combinations;
“wild” symbols that cause the display of substitute symbols in randomly selected symbol positions;
bonus symbols that awards a bonus prize, either as a monetary amount or as a bonus credit;
wild multiplier symbols that cause the display of substitute symbols on the array 10 and multiplies the amount of any win from one of said predetermined winning combinations;
bonus wild symbols that cause the display of substitute symbols on the array 10 and awards a bonus prize;
symbols that cause the award of additional free plays of said game;
symbols that cause one or more of said symbol positions to be held static (typically one or more reels) and display substitute symbols on the array 10;
symbols that cause the same game symbol to be stacked in a group of symbol positions, typically the group being one or more reels;
symbols that cause the display of new game symbols on the array 10;
“reveal” symbols that cause a game symbol to reveal another game symbol; and
“replacement” symbols that cause one or more game symbols to be replaced by other game symbols in the array 10.

These game enhancing symbols do not modify the function or value of the game symbols 12 that appear on the arrays 10, but instead confer bonus prizes, free games or change existing game symbols for other game symbols (such as replacing picture, royal card or symbols belonging to a reel with wild/substitute symbols). Where the function of game symbols 12 have been changed or the game symbols 12 are replaced, then this modification can take effect with the next play of the game instead of applying to the result of the spun array 10. In another embodiment, the game enhancing symbols may indicate the duration in which its game enhancing element is applied, such as a predetermined number of spins or a predetermined time period.

In other embodiments, the game enhancing symbols include “collector”-type game enhancing symbols which award points or tokens. The collection of points or tokens during the base game and/or feature game leads to the trigger of additional prizes or game enhancing symbols, depending on the number of points or tokens that are collected. These additional prizes can include stand alone progressive jackpots, bonus prizes and super games, which are enhanced versions of free spins or games where there are greater pay outs or frequency of wins.

In other embodiments, the electronic gaming machine 1 also offers the player the opportunity to play in community games against other players in so-called tournament games, or even in player versus player games. This is typically implemented by electronically linking several electronic gaming machines 1 in a group within a gaming venue. The player versus player or tournament game can be played simultaneously by the players or can be staggered, with some players playing at one time and some players playing at another time in the same game. In this situation, the player versus player or tournament game comprises the award of an additional bonus prize in addition to the jackpot prizes in said selected available jackpot set.

It will be appreciated that the invention could include one or more additional feature games that are triggered by specific trigger symbols appearing in the feature game. Also, the additional feature games may also have trigger symbols that trigger further feature games in a cascading fashion. These additional and further feature games could have the same game play elements as the feature game or be different feature games entirely.

In another embodiment, the video screen 7 comprises a touch screen for use in addition to the player-actuatable buttons 6 so as to enable the player to select the bet level (such as bet denominations or bet per pay line 14) as well as other various features, such as making monetary bets for the game, initiating play of any base and feature games played and responding to any messages or requests issued on the electronic gaming machine 1 by the electronic game controller 4. In this case, the player may control when the reels start spinning and stop spinning, either individually or collectively, by simply touching the reels. Control over spinning of the reels can also be implemented through the buttons 6 on the console 3. This increases player interaction and provide the player with an opportunity to guess when a particular game symbol 12 may appear in the reels.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic devices, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer program configured to perform the invention. In this way the invention can be implemented in various ways on an electronic gaming machine. In a further aspect, the invention includes a gaming system configured comprising a central processing unit (such as a computer or computational processor) configured for communication with an electronic gaming machine to perform the invention. In a yet another aspect, the invention includes a non-transitory carrier medium carrying computer executable code that, when executed on a central processing unit configured for communication with an electronic gaming machine, causes said central processing unit to perform the invention. In this case, the non-transitory carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the feature of the player being able to selectively starting or stopping spinning of the reels and the feature of providing a multiple games having different array formats that are variable in size can be combined into a single electronic gaming machine. Similar combinations of two or more features from the above described embodiments or preferred forms of the invention can be readily made by one skilled in the art.

By providing a game array that varies in size and shape on each play of a game, the electronic gaming machine provides a variety of game play and unpredictability that encourages player excitement, as the probability of achieving winning combinations of game symbols also varies with the random changes to the array. All these advantages of the invention result in the player being more likely to retain interest in continuing to play the same electronic gaming machine. Furthermore, since the electronic game controller controls operation of the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine comprising:
a housing having a display for displaying a game array of randomly selected game symbols and an electronic game controller in electronic communication with said display for controlling the appearance of game symbols in said game array on the display, wherein said game array has at least one variable dimension;
wherein a game comprises displaying said randomly selected game symbols in said game array and predetermined winning combinations of game symbols causes said electronic gaming machine to pay winnings to a player; and
an input means for receiving commands from said player to operate said electronic gaming machine and initiate play of said game on said display, said input means being in electronic communication with said electronic game controller; wherein said electronic game controller in response to a command from said player via said input means commences play of said game by randomly selecting game symbols and transmitting a signal to said display to display said randomly selected game symbols;
said electronic game controller randomly determines the number of game symbols displayed in said game array for each play of said game on said game array, said randomly determined number of displayed game symbols being randomly selected from a minimum number to a maximum number of game symbols that can be displayed in said array; and
all of said game symbols displayed in said array are eligible to form at least one winning combination of game symbols for the payment of winnings by the electronic gaming machine.

2. The electronic gaming machine of claim 1, wherein the array includes a plurality of reels displayed within said game array and the number of game symbols displayed for each reel is randomly selected by the electronic game controller within a predetermined range.

3. The electronic gaming machine of claim 2, wherein the number of symbols randomly selected for each reel is determined independently of the other reels.

4. The electronic gaming machine of claim 2, wherein the predetermined range includes one or more game symbols.

5. The electronic gaming machine of claim 3, wherein the number of symbols randomly selected for each reel is determined independently of the other reels.

6. The electronic gaming machine of claim 1, wherein said at least one variable dimension comprises the size of one or more game positions in which said game symbols are displayed on said array.

7. The electronic gaming machine of claim 1, wherein said at least one variable dimension comprises the shape of said array on said display.

8. The electronic gaming machine of claim 7, wherein said electronic game controller randomly selects at least one array shape from a set of predetermined array shapes.

9. The electronic gaming machine of claim 7, wherein more than one array shape is selected randomly and is displayed on said display.

10. The electronic gaming machine of claim 8, wherein more than one array shape is selected randomly and is displayed on said display.

11. The electronic gaming machine of claim 1, wherein the array varies in said at least one dimension for at least two consecutive plays of said game, each said consecutive play being initiated by a bet made by said player.

12. The electronic gaming machine of claim 11, wherein the number of game symbols displayed is different for said at least two consecutive plays and the bet made by the player for each said consecutive game play is identical.

13. The electronic gaming machine of claim 11, wherein the number of game symbols displayed is different for said at least two consecutive plays and the bet made by said player for each said consecutive game play is different.

14. The electronic gaming machine of claim 1, wherein said winnings are paid on paylines comprising one or more game positions within the array.

15. The electronic gaming machine of claim 1, wherein said winnings are paid on patterns comprising one or more game positions within the array.

16. The electronic gaming machine of claim 1, wherein said array is formed by a symmetrical pattern of said randomly selected and displayed game symbols.

17. The electronic gaming machine of claim 1, wherein the number of game symbols displayed is less than the number of game positions randomly selected to be displayed by the electronic game controller.

18. The electronic gaming machine of claim 1, wherein said electronic game controller causes said array to display a variable number of game positions corresponding to said randomly determined number of game symbols so as to display said randomly determined number of game symbols in said array.

19. The electronic gaming machine of claim 1, wherein said game comprises a base game.

20. The electronic gaming machine of claim 1, wherein said game comprises a feature game.
